(19) United States
(12) Patent Application Publication
(10) Pub. No.: US 2006/0154512 A1
(43) Pub. Date: Jul. 13, 2006

(54) Pressure-welding connector and method of manufacturing the same

(75) Inventors: Tomohiko Shimizu, Shizuoka (JP); Kei Sato, Shizuoka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: YAZAKI CORPORATION, Tokyo (JP)

(21) Appl. No.: 11/252,713

(22) Filed: Oct. 19, 2005

(30) Foreign Application Priority Data
Jan. 7, 2005 (JP) 2005-002787

(51) Int. Cl. H01R 4/24

(52) U.S. Cl. 439/387

(57) ABSTRACT

For preventing interference between a pressure-welding terminal and a wire pressure-welding jig by eliminating spread of the pressure-welding terminal, by using a wire pressure-welding jig including a connector holding portion and a terminal guide wall, a connector housing is placed in the connector holding portion. The pressure-welding terminal in the connector housing is supported at both sides by the terminal guide walls, and a wire is joined with the pressure-welding terminal by pressure-welding, to be prevented from spreading the pressure-welding terminal. The pressure-welding connector includes a cutout for receiving the terminal guide wall to support the pressure-welding terminal, or includes a cutout for inserting the terminal guide wall in an upper opening side of the partition wall to support the pressure-welding terminal.

The priority application Number Japan Patent Application 2005-2787 upon which this patent application is based is hereby incorporated by reference.

### BACKGROUND OF THE INVENTION

1. Field of the Invention

This invention relates to a method of manufacturing a pressure-welding connector so as to join an electric wire with a pressure-welding terminal in a condition that the pressure-welding terminal in a connector housing is positioned and held by a terminal guide and the pressure-welding connector.

2. Description of the Related Art

FIG. 7 shows an embodiment of a usual method of manufacturing the pressure-welding connector (refer Patent Reference 1).

A pressure-welding connector 81 is structured by receiving pressure-welding terminals 84 in each terminal receiving section 83 arranged in parallel at a connector housing 82 made of synthetic resin as shown in FIG. 8, and by joining the pressure-welding terminal 84 and an electric wire 85 by pressure-welding. The terminal receiving section 83 is partitioned by right/left partition walls 90 and continuous to a mate terminal insertion opening 92 at a front end of the terminal receiving section 83. Usually, after receiving the pressure-welding terminal 84 in the terminal receiving section 83 as shown in FIG. 7, the electric wire 85 is joined with the pressure-welding terminal 84 by pressure from an upper side.

The electric wire 85 is an insulating-covered wire, and joined by pressure directly between a pair of right/left pressure-welding pieces 87 of the pressure-welding terminal 84 not to remove an insulating cover 85a. The pressure-welding piece 87 has a blade 87a inside at top end thereof. The insulating cover 85a is torn by the blade 87a, and a conductive portion 85b (core wire) is press-fitted along an inner surface of the pressure-welding piece 87, and clamped for connection by the pair of pressure-welding pieces 87.

A wire pressure-welding jig has a metallic pressure-welding blade 86 and a pair of metallic pressure-welding guides 88 arranged at right and left sides of the pressure-welding blade 86. The pressure-welding blade 86 has a groove (not shown) for clearing the pressure-welding piece 87. The pressure-welding guides 88 are located in the vicinity of an outside of a top end of the both pressure-welding pieces 87 to limit spreading of the pressure-welding pieces 87 when joining the wire by pressure-welding.

Reference Patent 1 is Japan Patent Application Laid Open No. H9-180776.

### SUMMARY OD THE INVENTION

Objects to be Solved

According to the usual pressure-welding connector as mentioned above, if there is a displacement of the pressure guide 88 or the terminal 84 when moving the pressure-welding guide 88 down toward the terminal 84, the pressure-welding guide 88 and the terminal 84 interfere each other to break the terminal or bring an error of pressure-welding the electric wire 85.

The displacement of the terminal 84 is caused by facts that a space 89 between the pressure-welding guide 88 and the terminal 84 is provided and a gap 91 between the terminal 84 and the partition wall 90 is provided for preventing deformation of the partition wall 90 of the connector housing 82 in a direction of a width of the partition wall 90 by the pressure when the terminal 84 spreads outwardly within the space 89 on joining the electric wire by pressure connecting. Thus, since the gap 91 between the terminal 84 and the partition wall 90 is provided, the pressure-welding connector 81 is increased in the direction of width thereof.

To overcome the above problem, objects of the present invention are to provide a method of manufacturing a pressure-welding connector, which can eliminate spreading and displacement of a pressure-welding terminal when joining an electric wire by pressure-welding, and prevent interference between the pressure-welding terminal and a wire pressure-welding jig, and join the wire securely by pressure-welding, and the pressure-welding connector.

How to Attain the Object of the Present Invention

In order to attain the object of the present invention, a method of manufacturing a pressure-welding connector according to an aspect of the present invention, by using a wire pressure-welding jig having a connector holding portion and a terminal guide wall, includes steps of placing a connector housing in the connector holding portion; supporting both sides of a pressure-welding terminal in the connector housing by the terminal guide wall; and joining the pressure-welding terminal and an electric wire, and the pressure-welding terminal is prevented from spreading, by the terminal guide wall.

According to an above structure, by placing the connector housing in the wire pressure-welding jig, at least one pair of terminal guide walls touches (abuts one or approaches very close to) outer surfaces of pressure-welding portion (both-side walls including a pair of right/left pressure-welding pieces) of one pressure-welding terminal to support the pressure-welding portion not to be outwardly spread. In this condition, the electric wire is joined with the pressure-welding portion by pressure-welding. The pressure-welding portion is joined securely with a conductive portion of the electric wire by a strong contact pressure not to be outwardly spread. A pressure-welding connector body is formed with the connector housing and the pressure-welding terminal, and the pressure-welding connector is formed by joining the electric wire with the pressure-welding terminal.

The method of manufacturing the pressure-welding connector according to the other aspect of the present invention, it is characterized in the method mentioned above in that the wire pressure-welding jig is provided at a holding block having the connector holding portion with the terminal guide wall.

According to the above structure, the connector housing is mounted on the holding block, and simultaneously the terminal guide wall supports the pressure-welding terminal not to be outwardly spread.

The method of manufacturing the pressure-welding connector according to the further aspect of the present invention, it is characterized in the method mentioned above in that the holding block is provided with a cover to be opened and closed freely for pressing the connector housing by the cover.

According to the above structure, by closing the cover from an upper side after placing the connector housing on the holding block, the connector housing is held stably by the cover without displacement in an up-down direction.

The method of manufacturing the pressure-welding connector according to the further aspect of the present invention, it is characterized in the method mentioned above in that the connector housing is provided at a bottom side with a cutout where the terminal guide wall is inserted for supporting the pressure-welding terminal.

According to the above structure, the terminal guide wall penetrates into the cutout at bottom half of the connector housing to support the pressure-welding terminal not to be spread in a wire pressure-welding process. After pressure-welding the wire, an upper half of the partition wall of the connector housing supports the pressure-welding terminal.

The method of manufacturing the pressure-welding connector according to the further aspect of the present invention, it is characterized in the method mentioned above in that a holding block having the connector holding portion is provided with a cover to be opened and closed freely, and the terminal guide wall is provided at said cover in the wire pressure-welding jig.

According to the above structure, by providing the connector housing at the holding block, when the cover is closed, the terminal guide wall simultaneously supports the both side of the pressure-welding terminal not to be spread.

The method of manufacturing the pressure-welding connector according to further aspect of the present invention, it is characterized in the method mentioned above in that a gap for passing a pressure-welding-terminal blade for pressing the electric wire between said gap is provided between the terminal guide walls.

According to the above structure, after placing the connector housing in the jig, the electric wire is joined by pressure-welding with the pressure-welding terminal, by passing the pressure-welding blade through the gap between the terminal guide walls. The electric wire is arranged in the gap between the terminal guide blades, and guided along the terminal guide wall. Thereby, the wire is led securely to the pressure-welding terminal.

The method of manufacturing the pressure-welding connector according to the further aspect of the present invention, it is characterized in the method mentioned above in that a groove for positioning is provided at the holding block, and the groove is engaged with the terminal guide wall.

According to the above structure, when the cover is closed, a front end of the terminal guide wall is positioned securely by engaging with the groove of the holding block. Thereby, possibility of displacement of the pressure-welding terminal and guiding error of the electric wire is eliminated.

The method of manufacturing the pressure-welding connector according to the further aspect of the present invention, it is characterized in the method mentioned above in that the connector housing is provided at an upper side with a cutout where the terminal guide wall is inserted for supporting the pressure-welding terminal.

According to the above structure, in the wire pressure-welding process, the terminal guide wall penetrates into the cutout at the upper half of the connector housing to support the pressure-welding terminal not to be spread. After the wire pressure-welding process, the partition wall at a bottom half of the connector housing supports the pressure-welding terminal stably.

A pressure-welding connector according to one aspect of the present invention being applied for the method of manufacturing the pressure-welding connector, mentioned above, is characterized in that the connector housing is provided with a cutout, from a bottom wall toward a partition wall thereof, for inserting the terminal guide wall therein to support the pressure-welding terminal.

According to the above structure, in the wire pressure-welding process, the terminal guide wall penetrates from the cutout at the bottom half of the connector housing to support the pressure-welding terminal not to be spread. After the wire pressure-welding process, the partition wall at the upper half of the connector housing supports the pressure-welding terminal stably. The cutout is preferably to be a hole or an opening.

A pressure-welding connector according to the further aspect of the present invention being applied for the method of manufacturing the pressure-welding connector, mentioned above, is characterized in that the connector housing is provided at an upper opening of a partition wall of the connector housing with a cutout for inserting the terminal guide wall therein to support the pressure-welding terminal.

According to the above structure, in the wire pressure-welding process, the terminal guide wall penetrates into the cutout at the upper half of the connector housing to support the pressure-welding terminal not to be spread. After the wire pressure-welding process, the partition wall at the bottom half of the connector housing supports the pressure-welding terminal stably. The cutout is preferably to be a recess.

Effects of the Present Invention

According to the invention, by placing the connector housing in the jig and simultaneously preventing spreading of the pressure-welding terminal in the wire pressure-welding process by abutting the terminal guide wall on the pressure-welding terminal, the interference of the jig and the pressure-welding terminal and deformation of the pressure-welding terminal by the interference are eliminated. Thereby, the electric wire is joined securely with the pressure-welding terminal by pressure-welding and reliability of joining the wire is improved. Since the electric wire is joined with the pressure-welding terminal not to be outwardly spread, displacement of an adjacent pressure-welding terminal by deformation of the partition wall of the connector housing by pressing is not eliminated. Thereby, interference of the jig and the adjacent pressure-welding terminal and deformation of the adjacent pressure-welding terminal by the interference in the wire pressure-welding process of the adjacent terminal is prevented.

According to the invention, the pressure-welding terminal is mounted on the holding block and simultaneously the pressure-welding terminal can be prevented from spread. Manufacturability of assembling is improved. A condition that the terminal guide wall supports the pressure-welding terminal can be recognized easily and securely.

According to the invention, the connector housing and the pressure-welding terminal therein can be supported stably without displacement by closing the cover, and reliability of joining the wire by pressure-welding is improved.

According to the invention, the connector housing is mounted on the holding block and simultaneously the pressure-welding terminal can be stably supported by inserting the terminal guide wall into the connector housing from a bottom side. Thereby, manufacturability of placing the connector housing can be improved.

According to the invention, the cover is closed and simultaneously the terminal guide wall supports the pressure-welding terminal not to be spread and presses the connector housing to be held stably. Thereby, manufacturability of placing the connector housing is improved.

According to the invention, the gap between the terminal guide wall also performs as a space for inserting the pressure-welding blade and guiding the electric wire. Thereby, the electric wire can be joined with the pressure-welding terminal securely without displacement.

According to the invention, the terminal guide wall is positioned securely to the connector housing on the holding block. Thereby, preventing spread of the pressure-welding terminal by the terminal guide wall and guiding the electric wire can be improved.

According to the invention, the cover is closed, and simultaneously the pressure-welding terminal can be supported stably by inserting the terminal guide wall into the connector housing from the upper side. Thereby, manufacturability of placing the connector housing is improved.

According to the invention, the connector housing is mounted on the holding block on the wire pressure-welding jig, and simultaneously the pressure-welding terminal can be supported stably by inserting the terminal guide wall into the connector housing from the bottom side. Thereby, interference of the jig and the pressure-welding terminal and deformation of the pressure-welding terminal by the interference are eliminated. Therefore, the electric wire can be joined securely with the pressure-welding terminal and reliability of joining the wire is improved. Since the pressure-welding terminal is joined with the wire not to be outwardly spread, displacement of the adjacent pressure-welding terminal by deformation of the partition wall of the connector housing is eliminated. Thus, the interference of the jig and the pressure-welding terminal, when the adjacent terminal is joined with the wire, and deformation of the terminal by that can be prevented.

According to the invention, the cover of the wire pressure-welding jig is closed, and simultaneously the pressure-welding terminal can be supported stably by inserting the terminal guide wall into the connector housing from the upper side. Thereby, interference of the jig and the pressure-welding terminal and deformation of the pressure-welding terminal by the interference are eliminated. Therefore, the electric wire can be joined securely with the pressure-welding terminal and reliability of joining the wire is improved. Since the pressure-welding terminal is joined with the wire not to be outwardly spread, displacement of the adjacent pressure-welding terminal by deformation of the partition wall of the connector housing is eliminated. Thus, the interference of the jig and the pressure-welding terminal, when the adjacent terminal is joined with the wire, and deformation of the terminal by that can be prevented.

The above and other objects and features of this invention will become more apparent from the following description taken in conjunction with the accompanying drawings.

### BRIEF DESCRIPTION OF THE DRAWINGS

FIG. 1 is an exploded perspective view showing a condition that a pressure-welding connector body is placed in a wire pressure-welding jig in a first embodiment of a method of manufacturing a pressure-welding connector and the pressure-welding connector according to the present invention;

FIG. 2 is a perspective view of one embodiment of a holding block of the wire pressure-welding jig;

FIG. 3 is an exploded perspective view of an embodiment of a connector housing and terminals structuring the pressure-welding connector body;

FIG. 4 is an exploded perspective view showing a condition of joining an electric wire by pressure-welding with the pressure-welding connector body by using the wire pressure-welding jig;

FIG. 4A is a cross-sectional view taken along line 4A-4A in FIG. 4;

FIG. 5 is an exploded perspective view showing a condition that a pressure-welding connector body is placed in a wire pressure-welding jig in a second embodiment of the method of manufacturing a pressure-welding connector and the pressure-welding connector according to the present invention;

FIG. 6 is an exploded perspective view showing a condition of joining the electric wire by pressure-welding with the pressure-welding connector body by using the wire pressure-welding jig;

FIG. 6A is a cross-sectional view taken along line 6A-6A in FIG. 6;

FIG. 7 is a vertical sectional view showing an embodiment of a method of manufacturing a pressure-welding connector by prior art;

FIG. 8 is a perspective view of an embodiment of a pressure-welding connector housing by prior art.

### DESCRIPTION OF THE PREFERRED EMBODIMENT

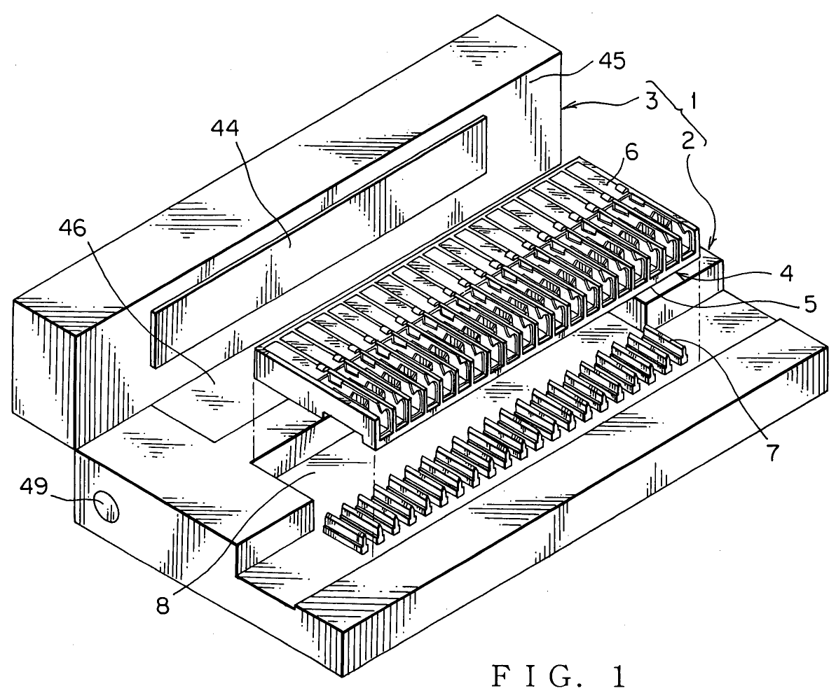

FIGS. 1-4A show a first embodiment of a method of manufacturing a pressure-welding connector and the pressure-welding connector according to the present invention.

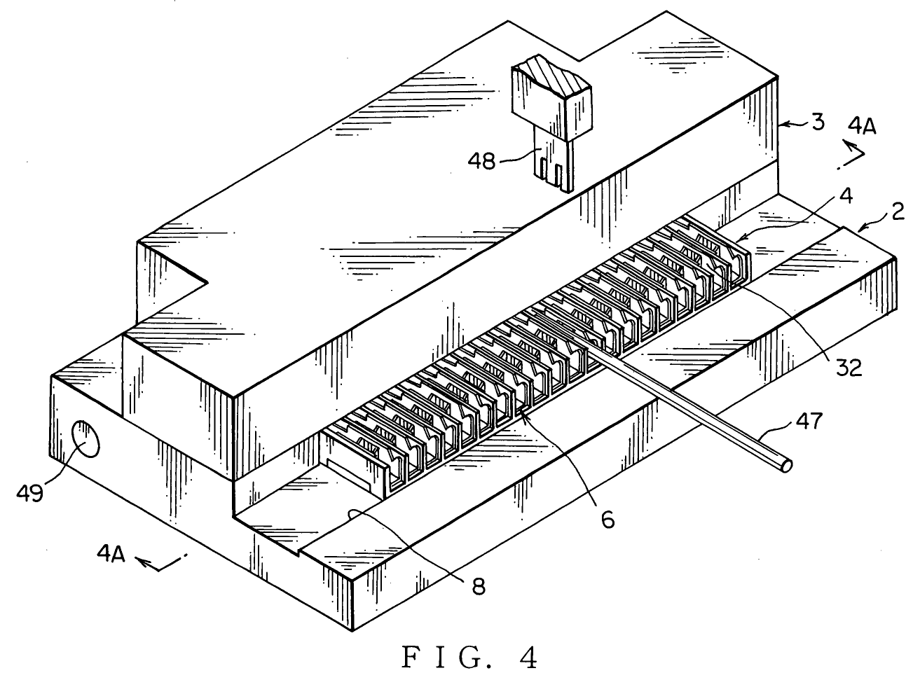

As shown in FIG. 1, the method of manufacturing the pressure-welding connector is by using a wire pressure-welding jig 1. The wire pressure-welding jig 1 is a connector holding tool including a metallic horizontal holding block 2 mounting a pressure-welding connector body 4 and a metallic cover 3 for pressing the pressure-welding connector body 4 on the holding block 2. The holding block 2 has a plurality of metallic terminal guide walls 7, in parallel, supported to be opened and closed (rotatable) freely by the holding block 2 to penetrate into a connector housing 5 made of synthetic resin of the pressure-welding connector body 4. The pressure welding connector body 4 includes the connector housing 5 made of synthetic resin and electric-conductive metallic pressure-welding terminal 6. The pressure-welding connector is formed by joining an electric wire (FIG. 4) with the pressure-welding terminal 6 by pressure-welding.

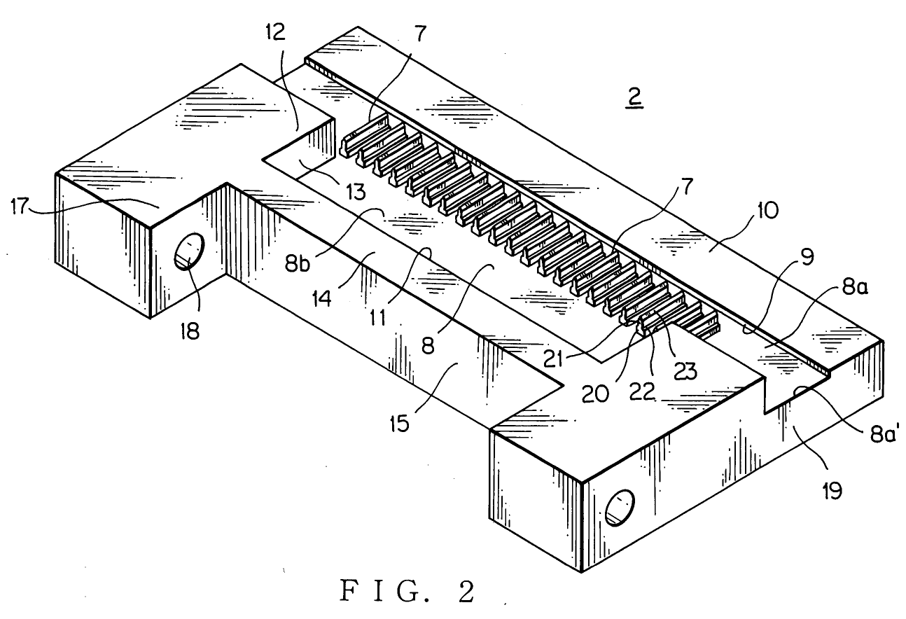

As shown in FIG. 2, the holding block 2 includes a connector holding groove 8 (connector holding portion) for holding the pressure-welding connector body 4 (FIG. 1) and a plurality of terminal guide walls 7 in parallel in a lateral direction (right-left direction) inside the holding groove 8. A front end of the holding groove 8 is continued through a low step surface 9 perpendicularly to a front wide short flat wall 10. A rear end of the holding groove 8 is continued through high step surfaces 11, 13 of a center recess 11 and projecting walls 12 at both sides of the recess 11 to a horizontal rear wall 14. The rear wall 14 has a deep recess 15 at a rear center thereof. Projecting walls 17 at both sides of the recess 15 are provided with shaft-engaged holes 18 to support a cover 3 (FIG. 1) rotatably.

A front half 8a of the holding groove 8 is formed wide in the lateral direction, and a rear half 8b of the holding groove 8 is formed in the recess 11 slightly narrower width than the front half 8a. Right/left ends 8a′ of the front half 8a of the holding groove 8 are cut out (opened) to be continued perpendicularly to the vertical both sides 19 of the holding block 2.

The plurality of terminal guide walls 7 is standing at even intervals in the front half 8a of the holding groove 8. A distance between a right end and left end of the terminal guide walls 7 is almost same as a width of the recess 11 at the rear half. Each terminal guide wall 7 has a wide base portion 20 extending perpendicularly from a bottom surface of the holding groove 8 and a narrow guide main body 21 extending perpendicularly from the base portion 20. The base portion 20 and the guide main body 21 are connected with right/left tapered slant surfaces 22. A top end (upper end) of the guide main body 21 formed into V-shape sharp point by right/left tapered slant surfaces 23.

In FIG. 1, the pressure-welding connector body 4 is placed in the holding groove 8, and simultaneously each terminal guide wall 7 penetrates into the pressure-welding connector body 4 so as to support right/left sides of the pressure-welding terminal 6 in the pressure-welding connector body 4. Thus, spreading of the pressure-welding terminal 6 is prevented when pressure-welding joins the electric wire. Details of this are described later with reference to FIG. 4A.

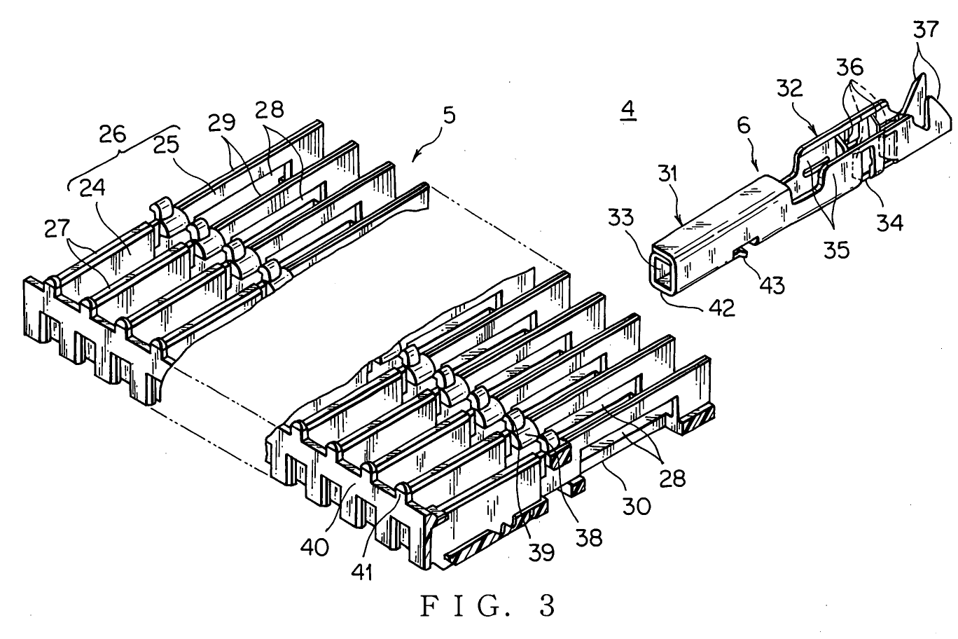

As shown in FIG. 3, the connector housing 5, made of synthetic resin, of the pressure-welding connector body 4 has a plurality of terminal receiving sections 26 in parallel in even intervals. Each terminal receiving section 26 includes a front half receiving section 24 and a rear half receiving section 25. The front half receiving section 24 has vertical partition walls 27 at right and left sides thereof. The rear half receiving section 25 has cutouts 28 at bottom sides of right/left thereof, and vertical right/left partition walls 29 continued to the cutouts 28. The cutout 28 is formed from the horizontal bottom wall 30 of the connector housing 5 to a rear half of the partition wall 29.

An electric contact portion 31 at a front half of the pressure-welding terminal 6 is received in the front half receiving section 24. A wire connecting portion 32 (pressure-welding portion) at a rear half of the terminal 6 is received in the rear half receiving section 25. Length of each rear half of the terminal 6 and terminal receiving section 26 is formed slightly longer than that of each front half thereof.

The electric contact portion 31 of the terminal 6 is formed as a female type into a rectangular cross-sectional cylinder 31. The cylinder 31 has an elastic contact (not shown) inside thereof, and an opening 33 for receiving a male terminal of a mating connector (not shown) at a front end of the cylinder 31. The wire connecting portion 32 of the terminal 6 has a horizontal base plate 34, side walls 35 projecting from both sides of the base plate 34, front/rear pairs of pressure-welding pieces 36 bent oppositely and inwardly from each side walls 35, and a wire cover pressure connecting portion 37 at a rear end.

An inner width between front partition walls 27, or rear partition walls 28 of the connector housing 5 is formed slightly wider than an outer width of the terminal 6. Thereby, the terminal 6 is inserted smoothly into the terminal receiving section 26 without sticking. To design a width margin to be minimum requirement, widthwise dimension (in a direction of terminal row) of the connector housing 5 can be miniaturized.

The terminal 6 can be inserted from an upper side or a rear side into the receiving section 26. When the terminal 6 is inserted, each bottom half of the side walls 35, from which the front/rear pairs of pressure-welding pieces 36 are bent, is exposed to the cutout 28 of the connector housing 5.

A locking projection 38 for preventing upward drawing-out of the terminal 6 is provided at a upper portion of a front end of the rear half partition 29. A hook 39 for a cover (not shown) or the upper layer connector housing 5 is provided at an upper side of the locking projection 38. A guide projection 41 for the cover or the upper layer connector housing is provided at an upper end of a front-end wall 40 perpendicular to the front half partition wall 27. A lock lance 43 for a hole or recess of the bottom wall 30 of the terminal receiving section 26 is provided at a bottom wall 42 of the electric contact portion 31 of the terminal 6.

As shown in FIG. 1, the cover 3 is provided with a wide projection 44 for pressing the front half partition wall 27 (FIG. 3) of the connector housing 5. The cover is provided with a hinge wall 46 perpendicular to a cover main body 45. Each shaft 49 of both sides of the hinge wall 46 is engaged rotatably with each hole 18 (FIG. 2) of both sides of the holding block 2.

As shown in FIG. 4, in a condition that the pressure-welding connector body 4 is placed in the wire pressure-welding jig 1, each electric wire 47 is joined with each terminal 6 by pressure-welding. The pressure-welding connector in which all electric wires 47 is joined by pressure-welding is inserted into a fitting section of the mating connector (not shown) and simultaneously the electric contact portion 31 of the terminal 6 is connected with a mating male terminal (not shown).

The front/rear direction of the pressure-welding connector body 4 and terminal 6 is defined oppositely to the front/rear direction of the jig 1. It is caused by that fitting face of the pressure-welding connector body 4 against the mating connector is defined as the front, and a direction of closing the cover 3 of the jig 1 is defined as the front.

In FIG. 4, when the pressure-welding connector body 4 is placed in the holding groove 8 of the holding block 2, and the cover is closed, the rear half of the pressure-welding connector body 4, that is, the wire connecting portion 32 of the terminal 6 is exposed at the front side of the cover 3, that is, at the front half of the holding block 2. The electric wire 47 is placed on the wire connecting portion 32 of the terminal 6, and the electric wire 47 is pressed from upper side by a pressure-welding blade 48 between the pair of pressure-welding pieces 36 (FIG. 3) of the terminal 6 to be joined by pressure-welding. The electric wire 47 is preferably positioned by abutting a top end thereof on a front end of the cover 3.

As shown in FIG. 4A (4A-4A cross-section view of FIG. 4) the pressure-welding connector body 4 is placed in the holding block 2, and simultaneously each terminal guide wall 7 projecting on the holding block 2 penetrates into each cutout 28 of the connector housing 5 and engages therewith. The guide main body 21 as the top half of the terminal guide wall 7 abuts on the outer surface of the both side walls 35, from which the pressure-welding piece 36 of the terminal 6 is bent, to prevent spreading of the both side walls 35. The terminal guide wall 7 is metallic, so that the terminal guide wall 7 is not deformed by being pushed by the both side walls 35 of the terminal 6.

Preferably, the inner width between each terminal guide walls is designed to be miniaturized, considering positive tolerance of the outer width dimension of the terminal 6. Thereby, there is almost no space between the inner surface of the each terminal guide wall 7 and the outer surface of the side wall 35 of the terminal 6, so that each terminal 6 is positioned and supported without looseness by each terminal guide wall 7.

In this condition, the electric wire 47 is pushed by the pressure-welding blade 48 (FIG. 4) and joined with the terminal 6 by pressure-welding. When the electric wire 47 is joined, both pressure-welding pieces 36 intend to spread outwardly. Since the terminal guide walls 7 at the both sides limit spreading of the terminal 6 not to be opened, the electric wire 47 is joined with the terminal 6 by a strong pressure-welding force. If a usual pressure-welding piece 36 is spread, the pressure-welding force (force clamping a core wire as a conductive portion of the electric wire 47 from both sides) becomes weaker. Such concern is eliminated.

The pressure-welding piece 36 is not spread, so that the interval of the terminals 6 can be decreased by bringing the partition 29 of an upper half of the connector housing close to the terminal 6. The pressure-welding connector body 4 can be miniaturized in the widthwise direction. The looseness in the widthwise direction of the terminal 6 is prevented, and reliability of connection between the mating terminal is improved. Since there is no displacement of the terminal 6, in the direction of widthwise of the pressure-welding piece 36, the interference between the pressure-welding blade 48 and the terminal 6, and breakage or deformation of the terminal 6 by the interference are prevented and the electric wire 47 is joined securely without pressure-welding error.

According to the embodiment, in FIG. 1, the pressure-welding connector body 4 receiving the terminal 6 is placed in the holding block. The connector housing 5 not receiving the terminal 6 can be placed in the holding block 2, and the terminal 6 is received in the connector housing 5 in that condition, and the electric wire 47 in FIG. 4 can be joined by pressure-welding. After the electric wires 47 are provided one by one on each terminal 6, the wire 47 can be joined by the pressure-welding blade 48 (in this case, the wire 47 can be joined also manually). After a plurality of electric wires 47 is provided simultaneously on each terminal, the electric wires 47 can be joined on by one by one pressure-welding blade 48 or the plurality of wires 47 can be joined simultaneously by a plurality of pressure-welding blade 48 (in this case, the wires 47 can be joined efficiently by automatic machine).

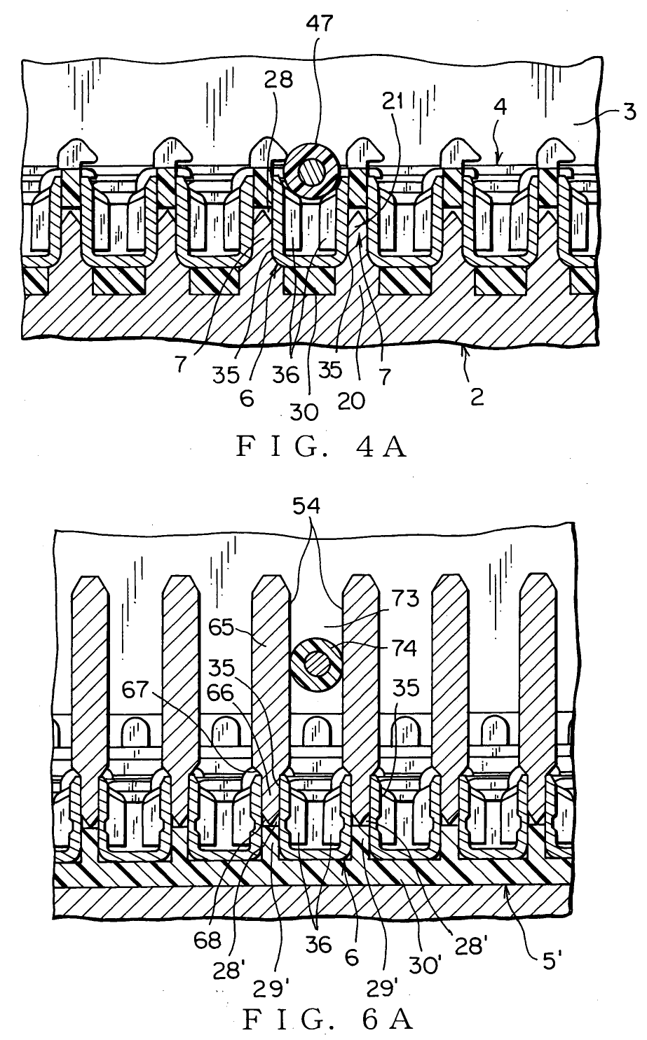

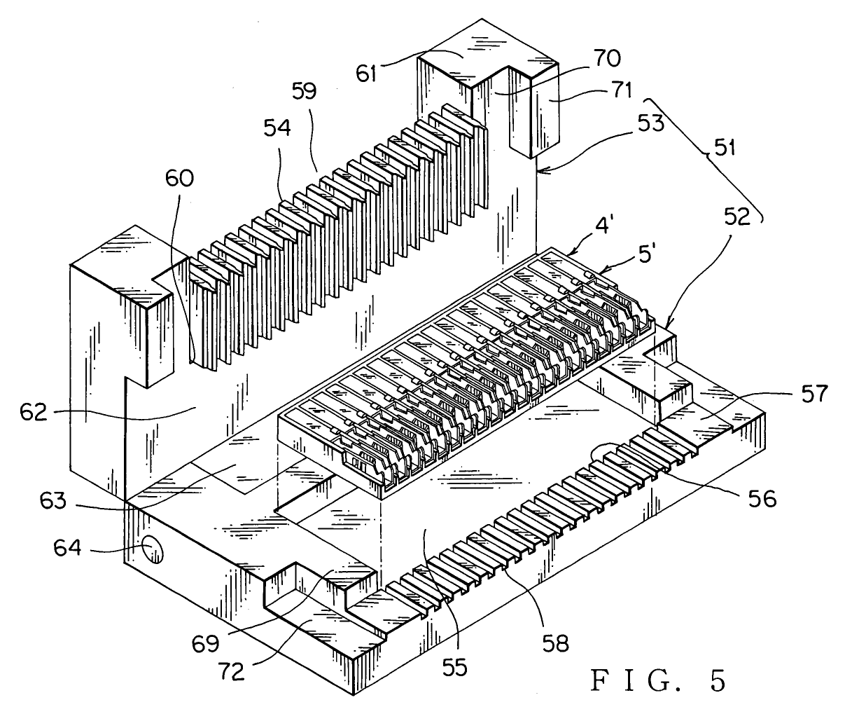

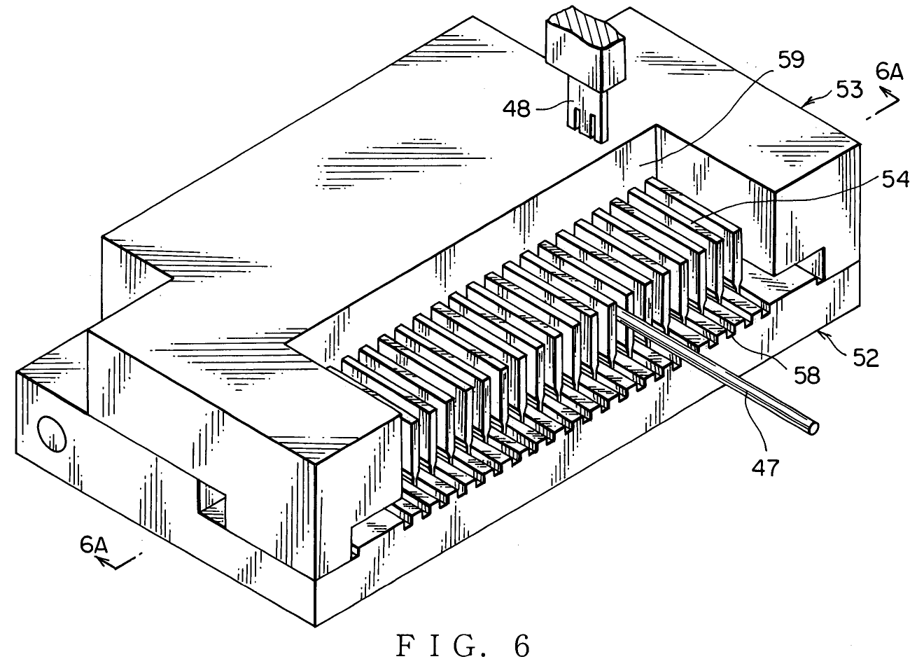

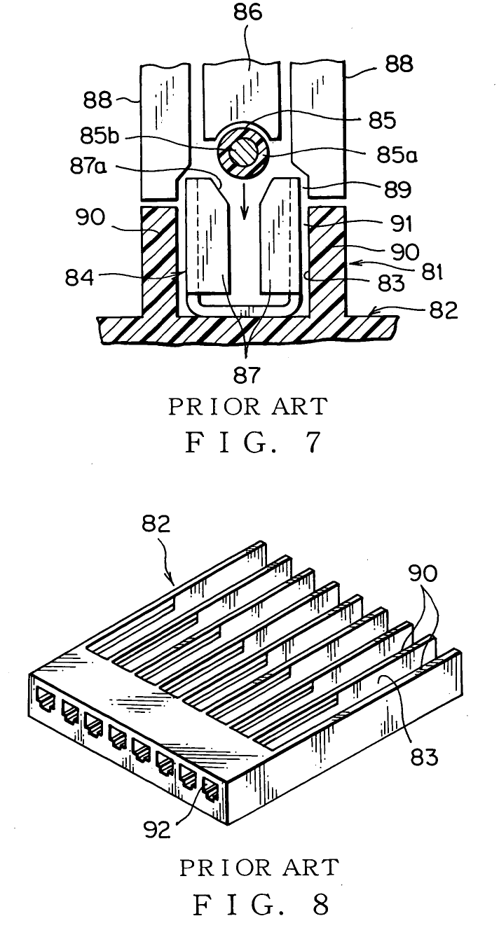

FIGS. 5-6A show a second embodiment of a method of manufacturing a pressure-welding connector and the pressure-welding connector according to the present invention. A figure of a terminal is the same as that shown in FIG. 3, and the same structure parts are given with the same markings and detailed description is omitted.

In this embodiment, a connector housing 5′ of a pressure-welding connector body 4′ does not include the cutout 28 at the bottom side of the connector housing 5 in FIG. 3, and a cut-off recess (cutout) 28′ (FIG. 6A) is formed at an upper half of a rear half of the partition 29′ (FIG. 6A) . Other figure thereof is the same as that of the connector housing 5 in FIG. 3, and description thereabout is omitted.

Instead of providing the terminal guide wall 7 at the holding block 2 of the, wire pressure-welding jig 1 according to the first embodiment, in a wire pressure-welding jig 51, as shown in FIG. 5, a terminal guide wall 54 is provided at a cover 53 mounted to be opened and closed freely on an upper side of a holding block 52. The holding block 52 and the cover 53 are made of metallic material.

The holding block 52 is provided with a connector holding groove 55 (connector holding portion). Grooves 58 for positioning terminal guide walls 54 of the cover 53 are arranged in even intervals in parallel on a wall 57 in front of a step surface 56 at a front side of the connector holding groove 55. The grooves 58 are formed between each projection to be arranged in parallel in a direction of terminal row.

The terminal guide walls 54 are arranged in even interval in parallel in a recess 59 of the cover 53. Each terminal guide wall 54 is formed into a plate-shape. The terminal guide walls 54 projects forwardly sawtooth-like from a rear wall 60 perpendicular to a recess 59 in a condition that the cover 53 is closed. The recess 59 is formed into a rectangular shape by cutting off from a front end 61 of the cover 53 rearwardly. The recess 59 has top, bottom and front openings for passing the pressure-welding blade 48 (FIG. 6) up-and-down therethrough. The cover 53 has a hinge wall 63 perpendicularly at a rear end of a cover main body 62. The hinge wall 63 is supported rotatably at the both side walls of the holding block 52 by a shaft 64.

As shown in FIG. 6A (6A-6A cross-sectional view in FIG. 6), each terminal guide wall 54 includes a top half long wide base portion 65 and a narrow guide main body 66 extending below from the base portion 65. The base portion 65 and the guide main body 66 are connected by a tapered slant surface 67. A front end (bottom end) of the guide main body 66 is sharpened in a V-shape by a tapered slant walls 68.

As shown in FIG. 5, a projecting wall 69 is provided at each front side of both sides of the connector holding groove 55 of the holding block 52. A corner groove 70 engaging with the projecting wall 69 for positioning is respectively provided at both sides of the cover 53. A projecting wall 71 is provided outside the corner groove 70. A groove 72 for engaging the projecting wall 71 of the cover 53 for positioning is provided outside the projecting wall 69 of the holding block 52.

As shown in FIG. 6, the cover 53 is positioned securely on the holding block 52 by these positioning means 69-72. The cover 53 is also positioned securely by engaging the front end bottom portion of the guide main body 66 (FIG. 6A) of each terminal guide wall 54 with the groove 58 of the wall 57 at front side of the holding block 52.

In FIG. 5, the pressure-welding connector body 4 is received in the connector receiving groove 55 of the holding block 52 so as to be positioned without displacement of front/rear and right/left. In FIG. 6 where the cover 53 is closed, the rear half of receiving section of the connector housing 5′, that is, the wire connecting portion 32 of the terminal 6 (FIG. 3) is positioned under the recess 59 of the cover 53. As shown in FIG. 6A, the guide main body 66 of the terminal guide wall 65 penetrates into a cutout 28′ at a top half of the partition wall 29′ of the terminal receiving section of the connector housing 5′, and engages with the cutout 28′. The guide main body 66 abuts on the outer surface of the both side walls 35 from which the pressure-welding pieces 36 of the terminal 6 projects inwardly. Thereby, the both side walls 35 including the pressure-welding piece 36 are prevented from spreading.

Preferably, the inner width between each terminal guide walls is designed to be miniaturized, considering positive tolerance of the outer width dimension of the terminal 6. Thereby, there is almost no space between the inner surface of the each terminal guide wall 54 and the outer surface of the side wall 35 of the terminal 6, so that each terminal 6 is positioned and supported without looseness by each terminal guide wall 54.

As shown in FIG. 6A, a low partition wall 29′ at a rear half of the connector housing 5′ is positioned in parallel with a minimum gap in the vicinity of a bottom half of the side wall 35 of the terminal 6. The guide main body 66 is positioned above the partition wall 29′, and a top end of the guide main body 66 abuts on a top end of the partition wall 29′. The electric wire 74 is inserted from the top into a gap 73 between each base portion 65 of the terminal guide walls 54 to be positioned securely against the terminal 6. The gap 73 between each base portion of the terminal guide walls 54 performs as a insertion gap of pressure-welding blade 48 in FIG. 6. In FIG. 6A, marking 30′ shows a bottom wall. The partition wall 29′ lower than the terminal 6 projects perpendicularly to the bottom wall 30′.

As same as the first embodiment, the terminal guide walls 54 are provide at both side of each terminal 6 so that number of the terminal guide walls 54 is one more than number of the terminal 6. Since outward spreading of the pressure-welding piece 36 of each terminal 6 is prevented by each terminal guide wall 54 when the electric wire 47 is joined by pressure-welding, the interference between the pressure-welding blade 48 and the terminal 6, and breakage or deformation of the terminal 6 by the interference are prevented and the electric wire 47 is joined securely without pressure-welding error.

As same as the first embodiment, the terminal 6 is prevented from outwardly spreading by the terminal guide walls 54 at the both sides thereof. Thereby, the electric wire 47 is joined with the terminal 6 by strong pressure-welding force, and the interval of the terminals 6 can be decreased by bringing the partition 29′ of an lower half of the connector housing 5 close to the terminal 6. The pressure-welding connector body 4′ can be miniaturized in the widthwise direction. The looseness in the widthwise direction of the terminal 6 is prevented, and reliability of connection between the mating terminal (not shown) is improved.

In FIG. 5, the connector housing 5′ not receiving terminal 6 can be placed in the holding block 52, and thereafter, the terminal 6 can be received into the connector housing 5′ , and the electric wire 47 in FIG. 6 can be joined by pressure-welding. After the electric wires 47 are provided one by one on each terminal 6, the wire 47 can be joined by the pressure-welding blade 48. After a plurality of electric wires 47 is provided simultaneously on each terminal, the electric wires 47 can be joined on by one by one pressure-welding blade 48 or the plurality of wires 47 can be joined simultaneously by a plurality of pressure-welding blade 48.

In FIG. 5, a wall (not shown) is provided at front end of the cover 53 (front side of the terminal guide wall 54) and the terminal guide wall 54 can be provided to be connected between the wall at the front end and a wall at rear side. A through hole 73 for inserting the pressure-welding blade is formed between each terminal guide wall 54. If a structure is designed to insert the pressure-welding blade 48 horizontally from the front side between each terminal guide wall 54 and move down the pressure-welding blade 48 toward the terminal 6 (join the electric wire 47 by pressure-welding), the through hole 73 passing the cover 53 in a up/down direction can be eliminated.

In above embodiments, the pressure-welding connector body 4 or 4′ having a plurality of terminals 6 is used. A wire pressure-welding jig having a pair of right/left terminal guide walls 7, 54 can be formed correspondingly to a pressure-welding connector body having one terminal 6.

In the above embodiments, the cover 3, 53 is provided rotatably through the hinge 49, 64 in the holding block 2, 52. Without any hinges, the cover 3, 53 as a separate part of the holding block 2, 52 can be mounted to be opened and closed freely on the holding block 2, 52. Instead of the connector holding groove 8, 55 of the holding block 2, 52, a connector holding space surrounding all sides by a projection (not shown) can be provided as a connector holding portion.

The method of manufacturing a pressure-welding connector as the above embodiments is also effective as a structure for joining wires by pressure-welding or a method for joining wires by pressure-welding by using the connector housing 5, 5′ having cutout 28, 28′ for escaping the terminal guide wall 7, 54.

Although the present invention has been fully described by way of examples with reference to the accompanying drawings, it is to be noted that various change and modifications can be made with the scope of the present invention as defined by the following claims.

1. A method of manufacturing a pressure-welding connector by using a wire pressure-welding jig having a connector holding portion and a terminal guide wall, comprising the steps of:
placing a connector housing in the connector holding portion;
supporting both sides of a pressure-welding terminal in the connector housing by the terminal guide wall; and
joining the pressure-welding terminal and an electric wire,
wherein the pressure-welding terminal is prevented from spreading, by the terminal guide wall.

2. The method of manufacturing the pressure-welding connector according to claim 1, wherein said wire pressure-welding jig is provided at a holding block having the connector holding portion with said terminal guide wall.

3. The method of manufacturing the pressure-welding connector according to claim 2, wherein the holding block is provided with a cover to be opened and closed freely for pressing the connector housing by said cover.

4. The method of manufacturing the pressure-welding connector according to claim 2, wherein the connector housing is provided at a bottom side with a cutout where the terminal guide wall is inserted for supporting the pressure-welding terminal.

5. The method of manufacturing the pressure-welding connector according to claim 3, wherein the connector housing is provided at a bottom side with a cutout where the terminal guide wall is inserted for supporting the pressure-welding terminal.

6. The method of manufacturing the pressure-welding connector according to claim 1, wherein a holding block having the connector holding portion is provided with a cover to be opened and closed freely, and the terminal guide wall is provided at said cover in the wire pressure-welding jig.

7. The method of manufacturing the pressure-welding connector according to claim 5, wherein a gap for passing a pressure-welding-terminal blade for pressing the electric wire between said gap is provided between the terminal guide walls.

8. The method of manufacturing the pressure-welding connector according to claim 5, wherein a groove for positioning is provided at the holding block, and said groove is engaged with the terminal guide wall.

9. The method of manufacturing the pressure-welding connector according to claim 6, wherein a groove for positioning is provided at the holding block, and said groove is engaged with the terminal guide wall.

10. The method of manufacturing the pressure-welding connector according to claim 6, wherein the connector housing is provided at an upper side with a cutout where the terminal guide wall is inserted for supporting the pressure-welding terminal.

11. The method of manufacturing the pressure-welding connector according to claim 7, wherein the connector housing is provided at an upper side with a cutout where the terminal guide wall is inserted for supporting the pressure-welding terminal.

12. The method of manufacturing the pressure-welding connector according to claim 8, wherein the connector housing is provided at an upper side with a cutout where the terminal guide wall is inserted for supporting the pressure-welding terminal.

13. The method of manufacturing the pressure-welding connector according to claim 9, wherein the connector housing is provided at an upper side with a cutout where the terminal guide wall is inserted for supporting the pressure-welding terminal.

14. A pressure-welding connector being applied for the method of manufacturing the pressure-welding connector, as claimed in claim 1, wherein the connector housing is provided with a cutout, from a bottom wall toward a partition wall thereof, for inserting the terminal guide wall therein to support the pressure-welding terminal.

15. A pressure-welding connector being applied for the method of manufacturing the pressure-welding connector, as claimed in claim 2, wherein the connector housing is provided with a cutout, from a bottom wall toward a partition wall thereof, for inserting the terminal guide wall therein to support the pressure-welding terminal.

16. A pressure-welding connector being applied for the method of manufacturing the pressure-welding connector, as claimed in claim 3, wherein the connector housing is provided with a cutout, from a bottom wall toward a partition wall thereof, for inserting the terminal guide wall therein to support the pressure-welding terminal.

17. A pressure-welding connector being applied for the method of manufacturing the pressure-welding connector, as claimed in claim 4, wherein the connector housing is provided with a cutout, from a bottom wall toward a partition wall thereof, for inserting the terminal guide wall therein to support the pressure-welding terminal.

18. A pressure-welding connector being applied for the method of manufacturing the pressure-welding connector, as claimed in claim 5, wherein the connector housing is provided with a cutout, from a bottom wall toward a partition wall thereof, for inserting the terminal guide wall therein to support the pressure-welding terminal.

19. A pressure-welding connector being applied for the method of manufacturing the pressure-welding connector, as claimed in claim 6, wherein the connector housing is provided at an upper opening of a partition wall thereof with a cutout for inserting the terminal guide wall therein to support the pressure-welding terminal.

20. A pressure-welding connector being applied for the method of manufacturing the pressure-welding connector, as claimed in claim 7, wherein the connector housing is provided at an upper opening of a partition wall thereof with a cutout for inserting the terminal guide wall therein to support the pressure-welding terminal.

21. A pressure-welding connector being applied for the method of manufacturing the pressure-welding connector, as claimed in claim 8, wherein the connector housing is provided at an upper opening of a partition wall thereof with a cutout for inserting the terminal guide wall therein to support the pressure-welding terminal.

22. A pressure-welding connector being applied for the method of manufacturing the pressure-welding connector, as claimed in claim 9, wherein the connector housing is provided at an upper opening of a partition wall thereof with a cutout for inserting the terminal guide wall therein to support the pressure-welding terminal.

23. A pressure-welding connector being applied for the method of manufacturing the pressure-welding connector, as claimed in claim 10, wherein the connector housing is provided at an upper opening of a partition wall thereof with a cutout for inserting the terminal guide wall therein to support the pressure-welding terminal.

24. A pressure-welding connector being applied for the method of manufacturing the pressure-welding connector, as claimed in claim 11, wherein the connector housing is provided at an upper opening of a partition wall thereof with a cutout for inserting the terminal guide wall therein to support the pressure-welding terminal.

25. A pressure-welding connector being applied for the method of manufacturing the pressure-welding connector, as claimed in claim 12, wherein the connector housing is provided at an upper opening of a partition wall thereof with a cutout for inserting the terminal guide wall therein to support the pressure-welding terminal.

26. A pressure-welding connector being applied for the method of manufacturing the pressure-welding connector, as claimed in claim 13, wherein the connector housing is provided at an upper opening of a partition wall thereof with a cutout for inserting the terminal guide wall therein to support the pressure-welding terminal.
